(19) United States
(12) Patent Application Publication
(10) Pub. No.: US 2005/0142925 A1
(43) Pub. Date: Jun. 30, 2005

(54) Quick cable connector for electrical devices and components

(76) Inventor: Claudia Adriana Mugnaini, San Vicente De Montalt (ES)

Correspondence Address: DARBY & DARBY P.C., P. O. BOX 5257, NEW YORK, NY, 10150-5257, US

(21) Appl. No.: 11/016,329

(22) Filed: Dec. 17, 2004

Related U.S. Application Data
(63) Continuation of application No. PCT/ES03/00308, filed on Jun. 23, 2003.

(30) Foreign Application Priority Data
Jun. 26, 2002 (AR) M 02 01 02404

(51) Int. Cl. H01R 4/24

(52) U.S. Cl. 439/411

(57) ABSTRACT

An electric connector system for connecting in a quick and easy manner an electrical cable to an electric device, the system comprising a box with electrical contacts and orifices for inserting one or more cables to be electrically connected to the electrical contacts, each orifice including a rotating arcuate peeling and contacting blade for peeling an insulating cover of the cable and entering into electrical contact with a conductive wire of the cable, and elastic pressing plates, with ribs for pressing the cable against the blade into an electrical and mechanical connection.

### CROSS REFERENCE TO PRIOR APPLICATION

This application is a continuation of copending International Application No. PCT/ES2003/000308, filed Jun. 23, 2003 and claims benefit of Argentinean Patent Application No. M 02 01 02404, filed Jun. 26, 2002, which is incorporated by reference herein. The International Application was published in Spanish on Jan. 8, 2004 as WO 2004/004074 A1 under PCT Article 21(2).

### BACKGROUND OF THE INVENTION

1. Field of the Invention

The present invention relates to the field of electrical devices or components wherein one or more cables, generally made by a core wire assembly insulated by an outer cover or sheath, must be electrically connected to an electric device or component, such as a socket or switch device of the type that is installed into a wall box, or any other electrical apparatus or component, and more particularly the invention relates to connector means for an instantaneous connection of the cable to the device or component without the need of peeling off and preparing the cable tip and with the cable establishing an efficient connection as well as a perfect fastening within the electrical device or component for preventing the cable from being pulled out and disconnected from the device or component.

2. Description of the Prior Art

It is well known to provide the switches and sockets that are installed into the wall with several types of connectors for connecting the switches or sockets to the cables carrying the electric current. The preparation of the ends of the cables to be connected into specific connecting locations of the devices is necessary and this preparation involves the cutting and removal of the outer insulating cover or wrapping that generally is provided in the cables or electrical conductors of this type. The core wire generally comprises a plurality of conductive threads or filaments, that should be twisted by the fingers to insert the peeled cable end into an orifice of the switch or socket. A screw is generally provided to be fastened to keep the cable end into the orifice in contact with inner contacts of the device. This work not only is cumbersome but also time consuming.

In order to prevent the operator from having to perform the above disclosed working steps, quick connector systems have been developed. One of the most well known quick connectors comprises a housing with a metal resilient sheet therein, with the sheet—a spring sheet for example—, extending into the housing and in the same direction in which the cable is introduced. The sheet ends in a cutting edge in a bottom portion of the connector system and it forms a gap with the inner walls of the housing with the gap being smaller than the outer dimension of the cable. Thus, when the cable is introduced into the gap, the inner core wire of the cable is kept between the housing wall and the cutting edge, under the resilient force of the spring sheet. To establish an electrical connection between the cable, more precisely between the inner core wire of the cable and the resilient sheet, the cable must be slightly pulled out of the housing along a short distance in order to make the cable to move against the cutting edge of the resilient sheet to cause the cutting edge to be introduced through the insulating cover and enter into contact with the inner conductive wire. While this system has improved the above disclosed traditional connection steps, this new system still has its own drawbacks. For example, when an end of the cable is introduced into the housing it is difficult to see when the end of the cable has extended beyond the cutting edge of the resilient sheet to slightly pull out the cable. Even when the end of the cable is already beyond the cutting edge it is also difficult to determine the precise pulling force to pull the cable enough to make the cutting edge cut the plastic cover of the cable but not excessive to break the connection. In any event, if the cable connected according to the above system is to be disconnected, a tool must be inserted into the housing while pushing the cable into the housing to remove the cable from the connection system. This is very cumbersome and difficult to do.

According to another quick connecting system as disclosed in Argentine Patent No. AR 008604B3, a rotating cutting half-cylinder part is provided within of and transversely to an orifice into which a cable must be inserted. When the cable is inserted into the orifice the half-cylinder member is rotated in order that a cutting edge of the cylinder penetrates the plastic cover of the cable and enters into electric contact with the conductive wire. However, the process and materials necessary to obtain the solid peeling cylinder are expensive as long as the half cylinder member must be cut from an entire cylinder part and the ends of the half cylinder must be additionally worked to connect the cylinder, at one end thereof, to an actuating member and, at the other end thereof, to an electric contact.

It would be therefore convenient to have a new improved quick connection system that provides and easy and quick mechanical and electrical connection of an electric cable within an electric device or component such as a socket or a switch device and the like.

### SUMMARY OF THE INVENTION

It is therefore one object of the present invention to provide an electric connector system for connecting in a quick and easy manner an electrical cable to an electric device or component, the system comprising a box with electrical contacts and orifices for inserting one or more cables to be electrically connected to the electrical contacts, each orifice including a rotating arcuate peeling and contacting blade for cutting and/or peeling an insulating cover of the cable and entering into electrical contact with a conductive wire of the cable, and elastic pressing plates for pressing the cable against the blade into an electrical and mechanical connection.

It is also another object of the present invention to provide a quick connecting system for electrically connecting an electrical cable to an electric device or component, the cable comprising a conductive core wire having an outer insulating cover, the system comprising:
a box including electrical contacts and at least one orifice for inserting a cable to be electrically connected to the electrical contacts;
an arcuate peeling and/or cutting and contacting blade of electrical conductive material in the at least one orifice, the blade being rotatably mounted in the box to rotate along a circular path and having at least one cutting edge for cutting and/or peeling the cable insulating cover, in one or more parts, entering into electrical contact with the core wire when the cable is inserted into the at least one orifice; and
an elastic pressing plate mounted in the box in an adequate location to press the cable in a direction against the contacting blade to enhance the electrical contact between the core wire and the blade when the blade has been rotated to peel the insulating cover and to enter into electrical connection with the core wire.

It is a further object of the present invention to provide a quick connecting system for electrically connecting an electrical cable to an electric device or component, the cable comprising a conductive core wire having an outer insulating cover, the system comprising:
a box including electrical contacts and at least one orifice for inserting a cable to be electrically connected to the electrical contacts, the box comprising an inner non-conductive support, a non-conductive upper cap and a non-conductive lower cap, both caps being connectable to each other to enclose the inner support into the caps;
an arcuate cutting and contacting blade of electrical conductive material in the at least one orifice, the blade being rotatably mounted in the box to rotate along a circular path and having at least one cutting edge for cutting the cable insulating cover and entering into electrical contact with the core wire when the cable is inserted into the at least one orifice;
an elastic pressing plate mounted in the box in a location to press the cable in a direction against the contacting blade to enhance the electrical contact between the core wire and the blade when the blade has been rotated to peel the insulating cover and to enter into electrical connection with the core wire, and
the inner non-conductive support including a front surface with at least part of the electrical contacts being exposed to enter into contact with the rotating blade, the front surface also including supporting means for retaining the pressing plate adjacently a corresponding one of the exposed electrical contacts, and guiding means for rotatably receiving a lower end of the blade in electrical connection to the corresponding one of the exposed contacts.

The above and other objects, features and advantages of this invention will be better understood when taken in connection with the accompanying drawings and description.

### BRIEF DESCRIPTION OF THE DRAWINGS

The present invention is illustrated by way of example in the following drawings wherein:

FIG. 1 shows a perspective partially cross-sectional view of a socket device including the connector system of the invention;

FIG. 2 shows an exploded perspective view of the socket device of FIG. 1;

FIG. 3 shows a bottom perspective view of a peeling blade according to a preferred embodiment of the invention;

FIG. 4 shows a bottom exploded perspective view of the peeling blade of FIG. 3;

FIG. 5 shows a top plan partially cross-sectional view of a pressing plate, a peeling blade and a cable inserted in a gap between the plate and the blade;

FIG. 6 shows a view similar to FIG. 5 with the blade rotated in a position commencing to peel the insulating cover of the cable;

FIG. 7 shows a view similar to FIGS. 5 and 6 with the peeling blade entirely rotated into a connected position wherein the cable is retained between the plate and the blade and the conductive core wire is in electrical contact with the blade, and

FIG. 8 shows a detail at a larger scale of the electrical contact between the peeling blade and the conductive core wire under the pressure exerted by the pressing plate.

### DESCRIPTION OF THE PREFERRED EMBODIMENTS

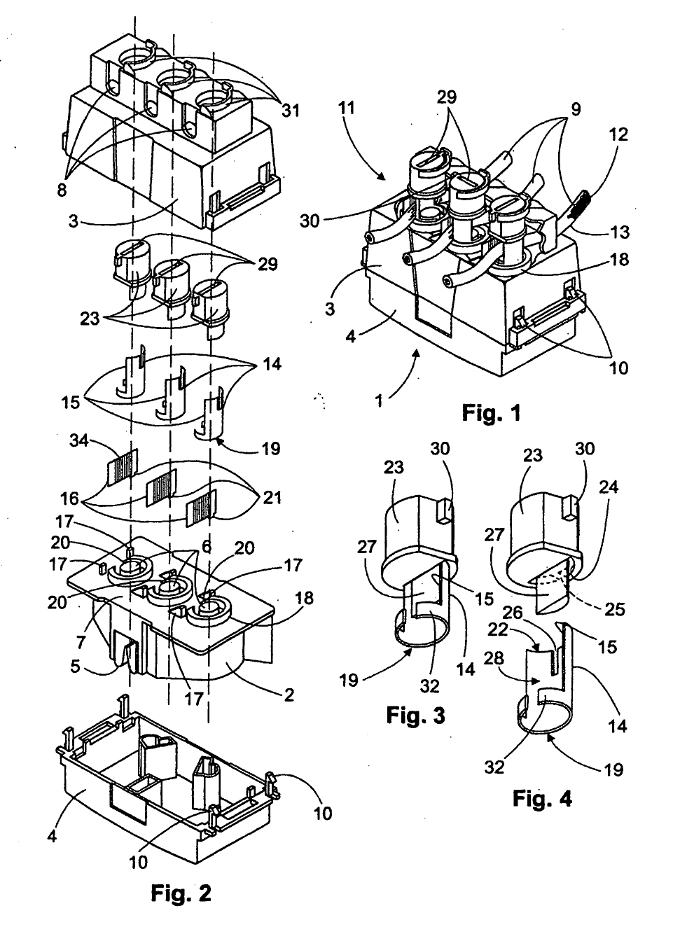

Now referring in detail to the drawings it may be seen from FIGS. 1 and 2 the arrangement of the invention in an electrical device, more particularly a socket device indicated by general reference 1. The device may comprise a box that may be formed, as better shown in FIG. 2, by the assembling of an inner support 2, an upper cap 3 and a lower cap 4, all made of non-conductive materials, such as plastics, resins and the like. Caps 3, 4 may be detachably assembled to each other to enclose or house inner support 2.

Inner non-conductive support 2 includes electrical contacts 5, 6, and a front surface 7 with at least part of some of the electrical contacts 6 being exposed at the surface. The number of contacts in the device will depend of the kind of device or component, such as a socket, a switch and the like. The illustrated socket includes three contacts as required in many countries but it may include only one or two contacts. Depending on the number of contacts, upper cap 3 includes orifices, preferably three orifices 8, for receiving one or more electrical cables 9, as illustrated in FIG. 1, to be electrically connected to electrical contacts 5, 6. Inner support 2 and caps 3, 4 may be firmly retained by latching means 10 for easily assembling and disassembling the box.

The system of the invention comprises a quick connecting arrangement, indicated by general reference 11, which is provided for electrically connecting each electrical cable 9 to electric device 1, with the cable comprising a conductive core wire 12 wrapped in an outer insulating cover 13. Core wire 12 may comprise only one conducting wire or a plurality of wires such as twisted filaments. The connector system preferably comprises an arcuate peeling and contacting blade 14 for each orifice 8. Blade 14 is made of electrical conductive material, such as copper and the like, and is rotatably mounted in the box, preferably in inner support 2, to rotate along a circular path. Blade 14, preferably having the shape of a partial cylinder or tube, is provided with at least one cutting edge 15 for peeling cable insulating cover 13 and entering into electrical contact with core wire 12 when the cable is inserted into one of orifices 8. While blade 14 has been shown as arranged transversely with regard to a longitudinal axis of orifice 8, blade 14 may be also arranged longitudinally relative the orifice, however the cutting edge moves preferably transversely to the longitudinal geometrical axis of the orifice.

The connector system also comprises a pressing plate 16, preferably an elastic metal plate, for each orifice 8, the plate being mounted in the box, preferably in the inner support, in a location proper to press the cable in a direction against the peeling and contacting blade to enhance the electrical contact between the core wire and the blade when the blade has been rotated to peel the insulating cover and to enter into electrical connection with the core wire as it will be better explained below.

Front surface 7 provides openings for permitting contacts 6 to be exposed-with the purpose of entering into electric contact with rotating blades 14. In addition, front surface 7 includes supporting means 17 for retaining the pressing plate adjacent to its corresponding exposed electrical contact 6, and guiding means 18 for receiving a rotatably lower end 19 of the blade in electrical connection with the corresponding exposed contact 6.

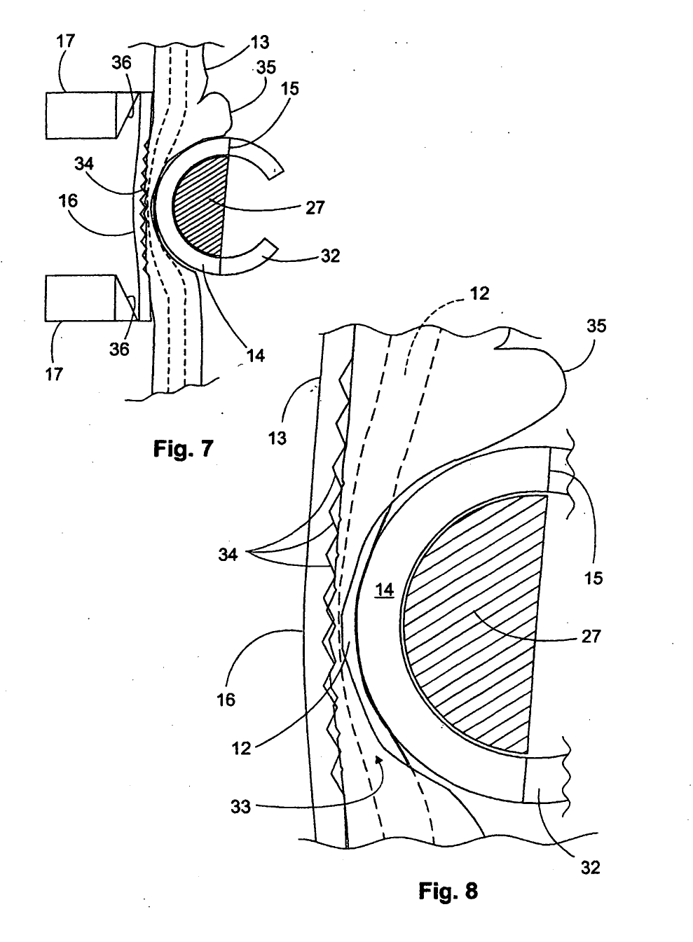

Preferably, the supporting means for retaining the pressing plate comprise a pair of uprising projections 17 and the guiding means for receiving a lower end of the blade comprise a cylindrical uprising rib 18. Pressing plate 16 is preferably retained between uprising projections 17 and cylindrical rib 18 is preferably made in a manner that plate 16 may resiliently move into an arcuate manner, thanks to inclined planes 36, as illustrated in FIGS. 7 and 8. In order to guarantee a correct installation of plates 16, a recess is located in front of surface 7, close to projections 17 and recess 20 receives a tongue 21 hanging from the pressing plate.

Arcuate blade 14 preferably comprises a metal sheet having a partial tubular shape, or cylindrical shape, extending in an arc having between about 90° to about 270°, preferably about 180°. Blade 14 has an upper end 22 connected to an insulated operating head 23 including a housing 24, FIG. 4, wherein upper end 22 of the blade is inserted into housing 24 to form an assembly to be operated by the user. More particularly, housing 24 is an arcuate groove including a rib 25 that is received into a notch 26 of the blade in order to affix the blade into the operating head to lock the blade and the head against relative rotation. Operating head 23 also includes a projection 27 extending along the blade and towards the lower end 19 of the blade to fill up a volume defined in an inner side 28 of the arcuate blade.

In order to be operated by the user, that is, to be rotated in order to make cutting edge to peel the cover 13 of the cable, operating head 23 includes a groove 29 for receiving a screwdriver by means of which the operating head together with the blade are altogether rotated. Stop means 30 are provided in the operating head to limit the rotation of the head and the blade not to overstep 180°. Stop means 30 actuates in cooperation with a rib 31 in upper cap 3 wherein the rib 31 prevents stop means 30 to rotate beyond the desired 1800.

Lower end 19 of peeling blade 14 also includes a strip portion 32 extending along an arc exceeding 180° wherein strip portion 32 is placed over a corresponding exposed electrical contact 6 to embrace the same and keep an electrical conductive connection with the contact.

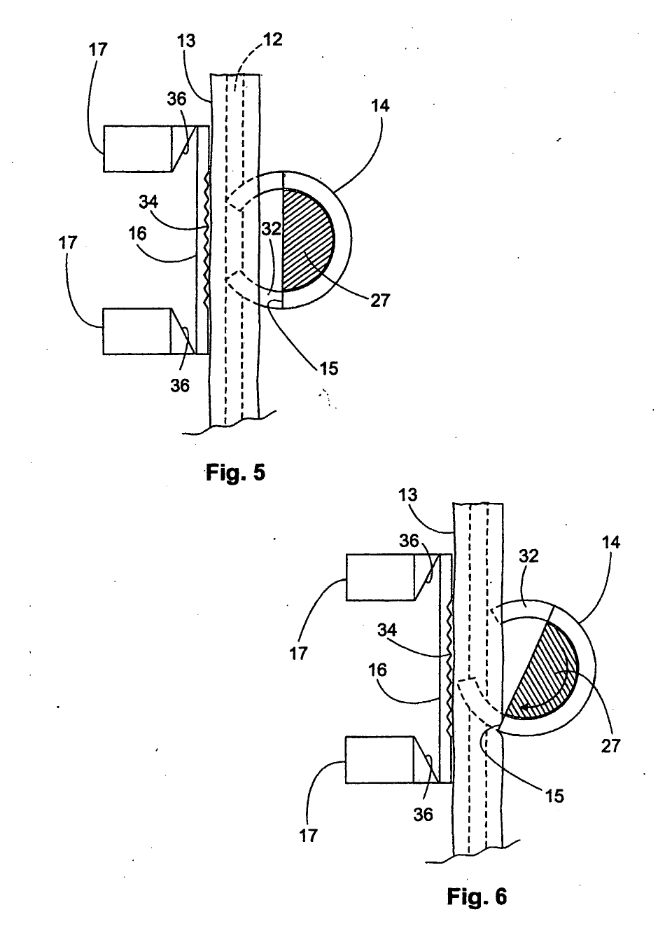

As stated above, blade 14 is rotatably mounted in the box assembly 2-4, between a disconnected position, shown in FIG. 5, wherein the corresponding orifice 8 is clear to introduce cable 9 therein, and a connected position, shown in FIGS. 7, 8, wherein the blade is in electrical connection to core wire 12. The disconnected position and the connected position are diametrically opposed positions in the circular path defined by the rotation of blade 14. Pressing plate 16 is located adjacent the connected position of blade 14 in order to define a gap 33 with the blade to receive cable 9 in a manner that the same remains gripped and pressed enough between the pressing plate and the blade to keep a desired electrical connection between core wire 12 and the blade, and a mechanical connection to prevent the cable from being pulled out of the device. Plate 16 includes a cable retaining surface, preferably a plurality of indentations 34, directed towards said blade to enhance the gripping and retention of the cable between the pressing plate and the blade.

In operation, socket device 1 is to be connected to an energy source, that is to cables 9 of a building wiring, for example. In order to have contacts 5, 6, connected to cables 9, core wire 12 must be put in electrical contact with exposed contacts 6. According to the invention, this operation is easily carried out as follows. Cable 9 is inserted into orifice 8 with peeling and/or cutting blade 14 in its disconnected position shown in FIG. 5. This position also corresponds to that one of right-side head 23 in FIG. 1. With the cable as shown in FIG. 1, a screwdriver or any other appropriate tool is inserted into groove 29 and head 23 is rotated as indicated with the arrow in FIG. 6, passing through an intermediate position, corresponding to the position of center head 23 of FIG. 1, up to a connected position shown in FIGS. 7, 8, and left-side head 23 of FIG. 1. With head 23 entirely rotated into the connected position, blade 14 is in electrical contact to core conductive wire 12 of cable 9 and both, blade 14 and wire 12 remain in contact under the force exerted by plate 16. Due to the cutting and/or peeling action of blade 14 over plastic cover 13, a portion 35 of cover 13 is formed at a side ahead of the direction of rotation of blade 14. The inventive connector provides a peeling and/or cutting of the cable that is larger than the one provided in other known connectors. For example, conventional connectors have spring blades which become wedged to cut the cover and enter into contact with the wire only along the cutting edge of the blade, thus providing only a small contact surface. The contact surface of the present invention is at least ten times the surface provided by conventional connector systems. The effect of this larger surface is enhanced by the pressure exerted by plates 16 which guarantee a reliable electrical contact and mechanical retention along extended periods of time.

In the event cable 9 is to be disconnected and removed from device 1, the head is rotated in the opposite sense, namely the counterclockwise direction for example, in order to have orifice 8 clear, and cable 9 is pulled out from the device. Portion 27 of head 23 will actuate in this event to prevent any cut-portion of the insulating cover, such as portion 35, from being retained into the arcuate blade when the blade is rotated to the disconnected position and the cable is pulled out of the device.

While the cable with its plastic cover may be inserted into the inventive connector system without the need of previously peeling the cable, the cable may be peeled as conventionally known and the peeled end may be inserted into orifice 8 and the inventive system operated as disclosed above. In like manner, one or more threads may be twisted and connected into orifice 8 as if they were an only one cable.

As to be understood from the above description, the present invention provides efficient electrical and mechanical connections not only for only one nominal size of cable but also for a wide number of nominal section-sizes of cables to be connected into the same connecting terminal. In addition, the pressure exerted over the contact surface is proportional to the current intensity circulating through the wire conductor, that is, with a higher current intensity the cable cross-section will be larger and this will provide a larger contact surface thus enhancing the mechanical retention and the electrical connection. The contact pressure is also constant along the time thus preventing the frequent servicing and maintenance as usual in conventional systems. This retention also enhances the resistance to vibrations and prevents the cable from slipping and sliding out from the connector.

While preferred embodiments of the present invention have been illustrated and described, it will be obvious to those skilled in the art that various changes and modifications may be made therein without departing from the scope of the invention as defined in the appended claims.

1. A quick connector system for electrically connecting an electrical cable to an electric device or component, the cable comprising a conductive core wire wrapped in an outer insulating cover, the system comprising:
a box including electrical contacts and at least one orifice for inserting a cable to be electrically connected to the electrical contacts;
an arcuate peeling and contacting blade of electrical conductive material in at least one orifice, the blade being rotatably mounted in the box to rotate along a circular path and having at least one cutting edge for peeling the cable insulating cover and entering into electrical contact with the core wire when the cable is inserted into the at least one orifice, and
a pressing plate mounted in the box in a location to press the cable in a direction against the contacting blade to enhance the electrical contact between the core wire and the blade when the blade has been rotated to peel the insulating cover and to enter into electrical connection with the core wire.

2. The system of claim 1, wherein the arcuate blade is a metal sheet extending in an arc of about 180°, the blade having an upper end connected to an insulated operating head an a lower end electrically rotatably connected to one of the electrical contacts of the device.

3. The system of claim 2, wherein the upper end of the blade is inserted into a housing in the operating head, the housing including a rib that is received into a notch of the blade in order to attach the blade into the operating head to lock the blade and head against a relative rotation.

4. The system of claim 3, wherein the lower end of the blade forms a strip portion extending along an arc exceeding 180° to embrace the one electrical contact and keep an electrical conductive connection with the one electrical contact.

5. The system of claim 1, wherein the blade is rotatably mounted between a disconnected position, wherein the at least one orifice is clear to introduce a cable therein, and a connected position, wherein the blade is rotated and is in electrical connection to the core wire, and wherein the disconnected position and the connected position are diametrically opposed positions in the circular path of the rotating blade.

6. The system of claim 5, wherein the pressing plate is located adjacent to the connected position of the blade in order to define a gap with the blade to receive the cable in a manner that the same remains gripped enough between the pressing plate and the blade to keep a desired electrical connection between the core wire and the blade and to prevent the cable from being pulled out of the device.

7. The system of claim 6, wherein the pressing plate includes a cable retaining surface directed towards said blade to enhance the gripping and retention of the cable between the pressing plate and the blade.

8. The system of claim 7, wherein the cable-retaining surface comprises a plurality of indentations.

9. The system of claim 1, wherein the operating head includes a projection extending along the blade and towards the lower end of the blade to fill up a volume defined in an inner side of the arcuate blade, the projection preventing any cut-portion of the insulating cover from being retained into the arcuate blade when the blade is rotated to the disconnected position and the cable is pulled out of the device.

10. The system of claim 1, wherein the electrical device is a socket device.

11. The system of claim 1, wherein the electrical device is a switch device.

12. The system of claim 1, wherein the box comprises an inner non-conductive support, a non-conductive upper cap and a non-conductive lower cap, both caps being connectable to each other to enclose the inner support into the caps, the inner mounting non-conductive support including a front surface with at least part of the electrical contacts being exposed to enter into contact with the rotating blade, the front surface also including supporting means for retaining the pressing plate adjacent one of the exposed electrical contacts, and guiding means for rotatably receiving a lower end of the blade in electrical connection to the one of the exposed contacts.

13. The system of claim 12, wherein the supporting means for retaining the pressing plate comprise a pair of uprising projections and the guiding means for receiving a lower end of the blade comprising a cylindrical uprising rib, with the pressing plate being retained between the uprising projections and the cylindrical rib, the front surface also having a recess for receiving a tongue hanging from the pressing plate.

14. The system of claim 12 wherein the arcuate blade is a metal sheet extending in an arc of about 180°, the blade having an upper end connected to an insulated operating head.

15. The system of claim 14, wherein the upper end of the blade is inserted into a housing in the operating head, the housing including a rib that is received into a notch of the blade in order to attach the blade into the operating head to lock the blade and the head against relative rotation.

16. The system of claim 15, wherein the lower end of the blade forms a strip portion extending along an arc exceeding 180° to embrace the corresponding exposed electrical contact and keep an electrical conductive connection with the one exposed electrical contact.

17. The system of claim 12, wherein the blade is rotatably mounted between a disconnected position, wherein the at least one orifice is clear to introduce a cable therein, and a connected position, wherein the blade is rotated and is in electrical connection to the core wire, and wherein the disconnected position and the connected position are diametrically opposed positions in the circular path of the rotating blade.

18. The system of claim 17, wherein the pressing plate is located adjacent the connected position of the blade in order to define a gap with the blade to receive the cable in a manner that the same remains sufficiently gripped between the pressing plate and the blade to keep a desired electrical connection between the core wire and the blade and to prevent the cable from being pulled out of the device.

19. The system of claim 18, wherein the pressing plate includes a cable retaining surface directed towards said blade to enhance the gripping and retention of the cable between the pressing plate and the blade.

20. The system of claim 19, wherein the cable-retaining surface comprises a plurality of indentations.

21. The system of claim 12, wherein the operating head includes a projection extending along the blade and towards the lower end of the blade to fill up a volume defined in an inner side of the arcuate blade, the projection preventing any peeled portion of the insulating cover from being retained into the arcuate blade when the blade is rotated to the disconnected position and the cable is pulled out of the device.

22. The system of claim 12, wherein the electrical device is a socket device.

23. The system of claim 12, wherein the electrical device is a switch device.

24. The system of claim 1, wherein the operating head includes a groove for receiving a screwdriver for rotating the head together with the blade.

25. The system of claim 12, wherein the operating head includes a groove for receiving a screwdriver for rotating the head together with the blade.

26. The system of claim 1, wherein the operating head includes stop means to limit the rotation of the head and blade not to overstep 180°.

27. The system of claim 12, wherein the operating head includes stop means to limit the rotation of the head and blade along 180°.
